(19) United States
(12) Patent Application Publication
(10) Pub. No.: US 2013/0346213 A1
(43) Pub. Date: Dec. 26, 2013

(54) Brand Promotion in a Social Networking System

(71) Applicants: Spencer Powell, Menlo Park, CA (US); Sean Michael Bruich, Palo Alto, CA (US)

(72) Inventors: Spencer Powell, Menlo Park, CA (US); Sean Michael Bruich, Palo Alto, CA (US)

(21) Appl. No.: 13/532,975

(22) Filed: Jun. 26, 2012

(51) Int. Cl. G06Q 30/02

(52) U.S. Cl. 705/14.66; 705/14.49; 705/319

(57) ABSTRACT

A social networking system enables brands to form relationships with each other and use these relationships when communicating content to social networking system users. The social networking system receives an endorsement request from a brand to establish a relationship with another brand in the social networking system. Responsive to an approval from the other brand, the relationship is formed by the social networking system, and may be used to distribute content to users connected to one of the brands. For example, a brand may endorse an advertising brand, allowing the advertising brand to target the endorsement to users connected to the endorsing brand. The advertising brand may provide content, such as an advertisement, as well as the endorsement.

### BACKGROUND

This disclosure relates generally to brand promotion in a social networking system.

Social networking systems have historically focused on relationships and connections between individual users of the social networking system. Commonly, users of a social networking system are users who establish connections, share content, and relate to one another using the social networking system. However, non-individual entities, such as brands, have an increasing presence in social networking systems, allowing users of a social network to establish connections, or other relationships, with the non-individual entities. For example, individuals using a social networking system may establish relationships with a brand using the social networking system, allowing the individuals to show their interest in the brand.

Typically, an individual using the social networking system connects with brands the individual knows, and may discover new brands viewing profiles maintained by the social networking system of other individuals connected to the individual. This allows the individual to see brands liked by, or connected to, the other individuals. While individuals can also be introduced to brands by content in the social networking system sponsored by a brand, such as advertisements or stories sponsored by the brand, but this sponsored content often lacks a meaningful relationship to an individual, limiting its effectiveness in generating additional interest in the brand.

### SUMMARY

To increase the likelihood of interactions between social networking system users and brands having a presence, such as brand pages, in a social networking system, relationships between different brands may be used by a brand when advertising. Brands may establish relationships with each other in the social networking system and use those relationships as well as relationships between the brands and social networking system users when providing content to the users. For example, a brand may endorse an advertising brand, allowing the advertising brand to target the endorsement to users connected to the endorsing brand (“fans” of the endorsing brand). The advertising brand may provide an advertisement and/or additional content, in addition to the endorsement, to the fans of the endorsing brand.

To use relationships between brands, a brand requests creation of an endorsement in the social networking system between itself and another brand. In one embodiment, the brand endorsement is from an endorsing brand to an advertising brand, allowing the advertising brand to provide advertisements about the endorsement to fans of the endorsing brand. The advertisement may include social networking content provided by the endorsing brand in addition to the social networking content provided by the endorsing brand. Hence, an additional brand may increase the likelihood of engagement with a user by providing content from a brand the user has a relationship with as well as an endorsement between that brand and the additional brand. Different types of endorsement may be established, such as an endorsement from the advertising brand to the endorsing brand or a bi-directional relationship between advertising brand and endorsing brand.

The social networking system may also provide privacy and endorsement controls to allow brands to control the endorsements associated with the brand. For example, a brand may select the relationships between other brands that may be used in advertising, allowing the brand to regulate which additional brands may leverage a relationship when advertising. This allows a brand to control how it is used in advertisements and the amount of access other brands have to the brand's fans.

In addition, the social networking system may recommend or suggest connections to other brands for a brand to form. The social networking system may analyze joint fans of different brands to identify additional brands with which a brand may be interested in establishing a relationship. For example, the social networking system uses an absolute number of joint fans between a brand and candidate brands or calculates the percentage of fans of different candidate brands that are joint fans of the brand and the candidate brand.

### BRIEF DESCRIPTION OF THE DRAWINGS

FIG. 1 is a system overview of a social networking system according to one embodiment.

FIGS. 2A and 2B are conceptual illustrations of entity-entity endorsements according to embodiments.

FIG. 3 is an advertisement including an entity-entity endorsement according to one embodiment.

FIG. 4 is a conceptual illustration of an endorsement recommendation according to one embodiment.

The Figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A method is provided for establishing advertising for a non-user entity within a social networking system which advertises the non-user entity's relationship to another non-user entity. An advertisement is provided to users who have a relationship with one of these non-user entities to advertise the relationship.

Users of the social networking system comprise individuals and non-individual entities. As used herein, “individual” refers to a person using the social networking system. More specifically, an individual is represented in the social networking system by user profiles and by connections to other individuals and social networking entities. The connections formed between individuals can be explicit, such as an individual expressly indicating a relationship to another individual, or implicit, such as a user belonging to a similar group or interacting with another user's profile.

A brand is used herein to broadly include any non-individual entity in a social network. A brand can be an organization, a corporation, a location, a public person (e.g. a public profile of a famous individual, which may be distinct from the famous individual's private user account), a band, a movie, or another non-individual entity with an account on the social networking system. A brand shares many attributes of individual users. For example, brands may have associated profile pages, news, content, and connections to other users or brands in the social networking system. Brands can also form connections with other brands or individuals may form connections to brands. For example, an individual may expressly “like” or be a “fan” of a particular brand. Connections between individuals and brands can be implicit and may be derived from user activity in the social network. Examples of this activity include an individual mentioning the brand on the individual's profile or the user interacting with the brand's profile page.

Brand to brand, or “brand-brand,” connections used for advertising are referred to herein as endorsements. An endorsement can comprise any positive relationship between brands in the social network. The endorsement can comprise a link between the brands in a social networking system. A brand can like, be a fan of, want, desire, use, or endorse another brand. As examples, a restaurant brand may indicate it serves a brand of liquor or cola. A movie star's public persona may wear a brand of sunglasses or “want” a new clothing line. A sports team visits particular away stadiums while a stadium hosts particular teams. The relationships formed between brands can be selected from a static list provided by the social networking system, or can be dynamically created by the brands. The social networking system may provide static options to define relationships between brands in order to ensure that relationships between brands are positive. Endorsements can be two-way (i.e. initiated by one brand and confirmed by another) or may be formed as one-way connections without confirmation.

### System Overview

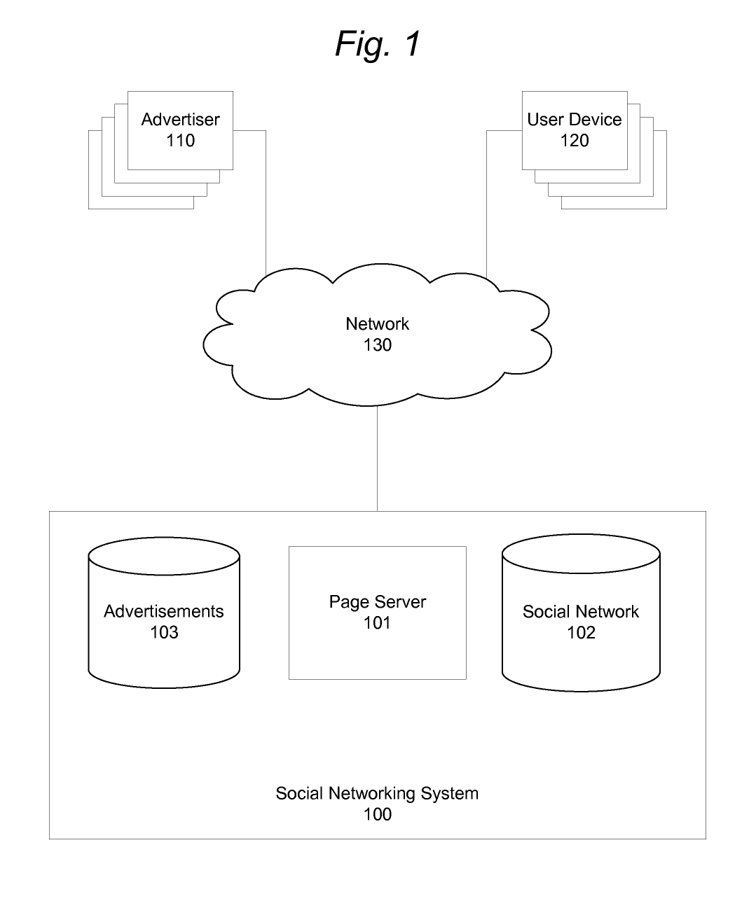

FIG. 1 shows a social networking system according to an embodiment. The social networking system 100 is connected to a plurality of user devices 120 and advertisers 110 using a network 130.

User devices 120 can be any device operated by a user for connecting with the social networking system 100. User devices 120 typically include a display and an input device to allow users to view and interact with content provided by the social networking system 100. A user device 120 can be a computer, mobile device, tablet, set-top box, computer kiosk, or any other computing device. The user devices 120 can communicate with the social networking system 100 to establish an account, log in to the account, and interact with content. Users may form connections with other users, post content, and otherwise interact with other entities within the social networking system.

Advertisers 110 may also maintain accounts in the social networking system 100. The advertiser accounts allow advertisers to provide and maintain content in the social networking system 100 relating to the advertisers 110. Like individuals, advertisers may also maintain a profile and other information about the advertiser in the social networking system 100, and may create and maintain connections with users and with non-user entities. The advertisers 110 can be similar computing devices to those of the user devices 120. The advertisers 110 may identify advertisements for presentation to individuals of the social networking system 100. Advertisements identified by the advertisers 110 can promote a relationship between an advertiser and another non-individual entity in the social networking system 100.

The social networking system 100 includes components for maintaining a social network 102 which stores connection information relating various individuals and non-individuals in the social networking system. For example the social network 102 includes information about an individual's connections to other individuals and to brands. The social network 102 also includes user profiles, which include information such as an individual's age, location, preferences, and other information about the individual. The user profiles may include brand profiles, which provide information about a brand. Examples of data included in a brand profile include users connected to the brand, a brand name, a brand location or other information describing the brand. Some of the user profile information may reflect information about other social networking entities. For example an individual may state in the profile that the individual is fond of, likes, or enjoys specific movies, television shows, sports teams, and other brands, which may represented as distinct entities in the social network 102. These relationships are stored as connections in the social network 102.

As user devices 120 access the social networking system, the social networking system uses a page server 101 to construct and serve pages for the social networking system 100. User devices 120 request information from the page server 101 and navigate to various aspects of the social networking system 100 by interacting with information provided by the page server 101. The page server 101 provides the requested content and enables navigation of the social network 102 by the user devices 120. Along with serving content relating to the social network 102, the page server 101 may also attach advertising content along with the social networking content. In one embodiment, the page server 101 identifies advertisements from a database of advertisements 103. The advertisements 103 include advertising content for an advertiser, such as an advertisement graphic, an advertisement's text, an advertisement's price and/or other parameters of the advertisement. One or more advertisements may also include targeting criteria of individuals that the advertiser desires to be served the advertisements. The advertisements 103 may provide information to the social networking system 100 for dynamically constructing an advertisement. For example, the social networking system may dynamically insert social networking content into an advertisement. The advertisements 103 include advertisements which incorporate endorsements between brands.

### Brand Endorsements

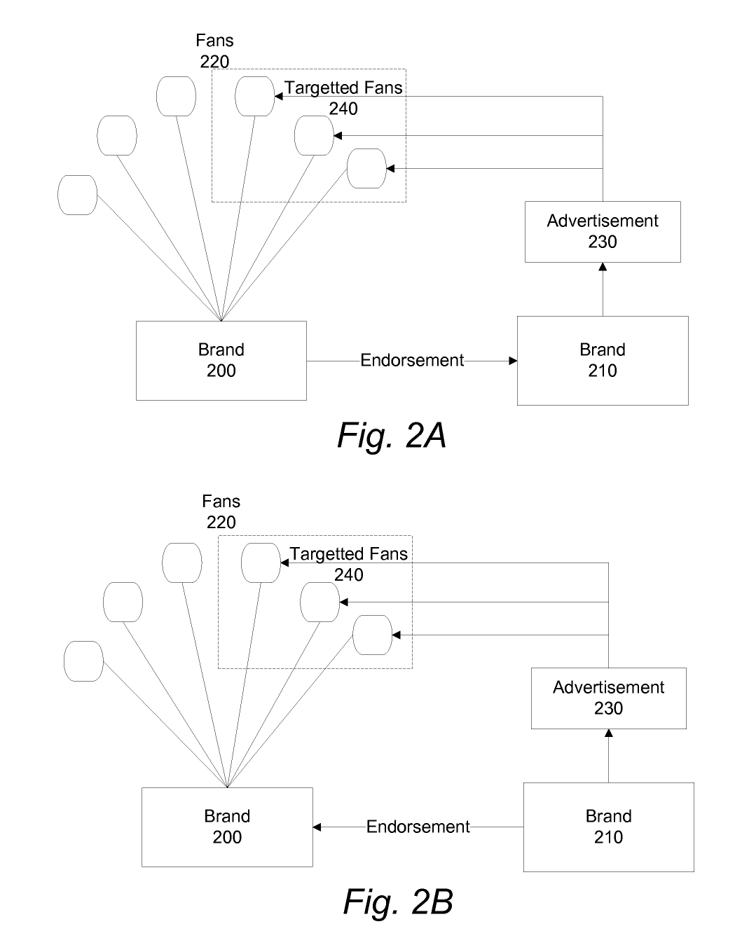

FIG. 2A illustrates the conceptual framework for an advertisement in a social network using a brand endorsement. A brand 200 is connected to a plurality of users in the social network. In one embodiment, the users 220 are individual users of the social network who have shown an interest in the brand 200 within the social networking system 100, referred to as “fans” 220 of the brand. For example, fans 220 may have provided an interest in the brand 200 by explicitly forming a relationship with the endorsing brand 200, or may have implicitly formed a relationship by interacted with the endorsing brand. An explicit relationship is formed by an individual user “liking” a brand in the social network. An implicit relationship is formed by an individual user interacting with a profile page of the endorsing brand, posting pictures associated with the endorsing brand, attending events held by the endorsing brand, and performing other actions within the social networking system associated with the brand.

An advertising brand 210, other than the brand 200, provides an advertisement 230 to targeted fans 211 of the brand 200. The targeted fans 240 are a subset of the fans 220 determined by a variety of factors depending on the embodiment. For example, the advertising brand 210 may have a set of preferred demographics to which the targeted fans belong. In one embodiment, the brand 200 endorses the advertising brand 210. The endorsement indicates a positive relationship between the brand 200, which is the endorsing brand, and the advertising brand 210. Examples of endorsements are further described above. Advertising brand 210 may use the endorsement by the brand 200 to determine the targeted fans 240. For example, the targeted fans 240 may be a portion of the fans 220 who have the strongest connection to the endorsing brand 200. The connection strength of a fan to the endorsing brand 200 can be measured, for example, by the frequency, last access, and/or nature of the relationship between the fan and the endorsing brand 200. The targeted fans 240 may also be chosen according to the tendency of individual fans to respond to previous endorsements by the endorsing brand 200.

Illustrated in FIG. 2A is an endorsement from the brand 200 to the advertising brand 210 according to an embodiment. In this embodiment, a targeted fan 240 receives an advertisement 230 indicating the brand 200, which is the brand to which the targeted user 240 is connected, or “likes,” endorses another brand, which is the advertising brand 210 in FIG. 2A. The endorsement from brand 200 to brand 210 can include any endorsement activity as described above, such as brand 200 liking brand 210 in the social network. In the example of FIG. 2A, advertising brand 210 may distribute an advertisement 230 promoting its endorsement by brand 200 to targeted fans 240 of the brand 200. In this way, the fans of the brand 200 are provided information about another brand that brand 200 likes or otherwise endorses. For example, the brand 200 may be the public profile of a famous actor who endorses a sunglasses brand 210. Targeted fans 240 of the actor are provided an advertisement 230 indicating that the actor endorses the sunglasses brand. In some embodiments, the endorsing information included in the advertisement 230—presented to the targeted fans 240 includes the specific endorsing activity by the brand 200. For example the advertisement 230 can indicate the brand 200 “wears” brand 210 or another endorsing activity performed by the brand 200.

FIG. 2B illustrates an endorsement from the advertising brand 210 to the brand 200 according to an embodiment. In the embodiment of FIG. 2B, a targeted fan 240 receives an advertisement 230 indicating the advertising brand 210 likes the brand 200, which is the brand to which the targeted fan 240 is connected. For example, if the targeted fan 240 likes a beverage company, a restaurant may advertise it “serves” beverages from the beverage company, “likes” beverages from the beverage company, or advertise another form of endorsement, to encourage the targeted fan 240 to visit the restaurant. While FIGS. 2A and 2B are examples of a one-way endorsement of a second brand by a first brand, the endorsement may be bi-directional relationship between two brands.

The establishment of an endorsement between brands may be controlled by the social networking system 100. For example, each brand controls the brands that connect to it and the brands to which it connects. This allows a brand to manage the brand-brand relationships including it and its brand-brand relationships that may be used in advertising. In one embodiment, any brand-brand relationship may be used in advertising. In another embodiment, a brand-brand relationship may be used in an advertisement if the non-advertising brand specifically agrees to the advertisement using the brand-brand relationship. This allows a brand to control how it is used in advertisements and how much access another brand has to the brand's fans.

### Advertisement Display

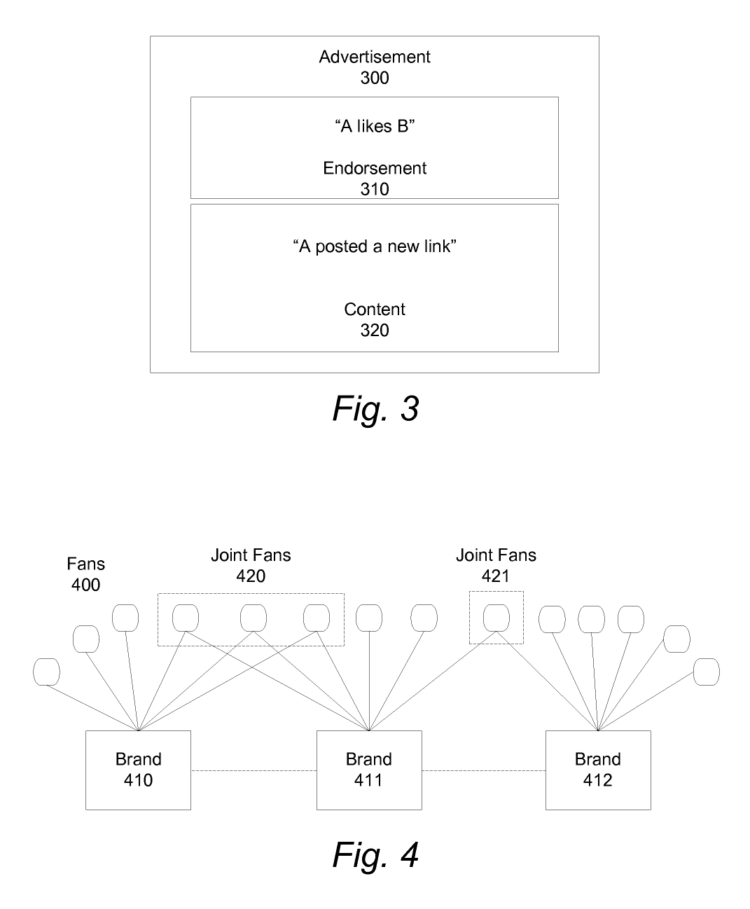

FIG. 3 is an advertisement 300 including a brand-brand endorsement according to one embodiment. The advertisement 300 is provided to a user in a display of the user device 120. In one embodiment, the advertisement 300 is presented to the user in a portion of the display which encloses advertisements. The portion including advertisements may be a specialized portion of the display or may be inserted between other content displayed to the user.

The advertisement 300 shown in FIG. 3 depicts an advertisement corresponding to the endorsement shown in FIG. 2A. In FIG. 3, brand A endorses brand B, and brand B seeks to advertise the endorsement of brand B by brand A. The user receiving the advertisement 300 is a fan of brand A. The advertisement 300 includes a portion for an endorsement 310 and a portion for content 320. The endorsement 310 describes an endorsement between brands in the social networking system. In FIG. 3, the endorsement involves the brand providing the advertisement. In FIG. 3, the endorsement 310 describes brand A endorsing brand B. The content 320 includes social networking content of the brand to which the user is connected. In FIG. 3, the content 320 includes content associated with brand A, such as a link, activity or news story posted by brand A. This allows the advertisement 300 to show a user information about a brand the user likes, as well as an endorsement by that brand of another brand. Because the advertisement includes information about a brand in which the user is already interested, the advertisement 300 is more likely to be of interest to the user. Hence, the advertisement 300 provides a more subtle endorsement that is more likely to be interesting to a user.

In different embodiments, the content 320 may be selected by the advertising brand (brand B in FIG. 3) when the advertising brand decides to run the advertising campaign, may be selected by the endorsing brand (brand A in FIG. 3), or may be dynamically selected. Dynamic content selection of content allows the social networking system to select content from the endorsing brand based on metrics likely to be of interest to the user. For example, content may be chosen based on the most recently posted information, based on user interests, based on prior user responses to previously posted information or other suitable metrics. The content 320 may be chosen from content provided to the social network by the endorsing brand, from the content provided by the advertising brand, or both. Content 320 may also be selected based on the types of products or services offered by the advertising brand.

In addition to the content 320 and endorsement 310 shown in FIG. 3, additional information may also be provided in the advertisement 300 and/or alternate layouts may be used. The advertisement may place content 320 at the top of the advertisement, followed by the endorsement 310, and below the endorsement 310 is content or information about the advertising brand. In addition, the advertising brand may state information about itself which is related to the endorsement or information about the advertiser which is related to the endorsing brand.

The endorsement 310 may also vary according to the relationship between the brands. For example, rather than an endorsement from brand A to brand B, the endorsement may be from brand B to brand A or may be an advertisement of a bi-directional endorsement/relationship between the two brands. For example, the owner of a restaurant can run an advertisement to promote the fact that the restaurant serves a particular beverage. In this case, the advertisement 300 is provided to users who like the particular type of beverage and includes content 320 that is from the beverage manufacturer, while the endorsement 310 indicates the advertising restaurant likes (or serves) the beverage. The advertisement 300 may provide further information about the relationship between the restaurant and the beverage, such as a long-standing relationship or a promotional deal. The restaurant can target the advertisements to fans of the beverage whose profile information indicate the user is geographically near the restaurant to further increase the likelihood the fans will be interested in the advertisement. In this way, an advertiser can leverage user interest in another brand, with which the advertiser has a relationship, to promote itself.

### Brand-Brand Relationships

To serve advertisements indicating brand-brand endorsements, these endorsements must be created and managed. The social networking system 100 provides tools for brands to manage relationships with other brands. Frequently, brand-brand relationships are commercial in nature, and a brand may be reluctant to allow its brand to be associated with another brand without commercial reimbursement. Additionally, a brand often desires to maintain or establish an association with concepts to stylize or promote itself. Examples of concepts include “edgy,” “cool,” “classy,” “exotic,” or other descriptions of user perception of the brand. These concepts are affected by the other brands which have a relationship to the brand; therefore, the brand may wish to curate these relationships and, in particular, control which relationships appear in any advertising. As such, the social networking system provides a brand with controls for regulating brands which can connect to it. These controls for controlling brand-brand connections can be maintained separately from controls allowing users to connect to the brands.

In one embodiment, the brand-brand connection control includes one or more settings enabling a brand to control the types of brands which are able to connect to the brand. For example, different brand settings may allow a brand to enable any other brand to connect to it, no brands to connect to it, or may individually allow or deny brands to connect to it. Additionally, a brand-brand connection control may allow a brand to designate types of brands which can connect to it. The social networking system may associate different types with brands. Examples of types of brands include location, type of entity associated with the brand, industry, products or services offered by a brand, keywords associated with the brand or other suitable data associated with a brand.

Brand connections can also be controlled by the type of connection or endorsement requested. Different connection capabilities can be enabled for each brand type. For example a beverage company may allow any brand having a type of “restaurant” to “serve” it, but request that other brand types request approval of the beverage company for other types of endorsements. This allows the beverage company to prevent undesirable public personas or competitor companies from endorsing the brand. Hence, a brand may easily control the brands able to be associated with it in the social network without causing an undue burden on the operator of the brand.

While controls have been described for connections and endorsements, the same controls may be employed for controlling whether the brand may be used in an advertisement by another brand. In some embodiments, the controls may differ between connections and advertising. For example, a brand may allow another brand to connect to it without review or approval, but disallow another brand from advertising using the brand without the brand's consent. In this way, brands can control the circumstances in which they are used in advertisements in conjunction with other brands.

### Advertising Methodology

FIG. 4 is a conceptual illustration of an endorsement recommendation according to one embodiment. In addition to advertising existing brand endorsements, the social networking system may also recommend endorsements for brands to form. Fans 400 are connected to various brands 410-12. The social networking system can analyze relationships between fans connected to different brands 410-12 to determine recommendations for endorsements between brands 410-12 to improve brand advertising. For example, a brand 411 may be considering a new advertising campaign and would like to promote an endorsement, but does not know whether to promote with a first additional brand 410 or with a second additional brand 412.

The social networking system can determine a recommended brand with which the brand 411 advertises. For example, the social networking system identifies which fans are joint fans 420 of the brand 411 and of the first additional brand 410 and which fans are joint fans 421 of the brand 411 and of the second additional brand 412. The joint fans 420, 421 may be used to identify which fans are more likely to be attracted to brand 411. As shown in FIG. 4, there are more joint fans 420 of the brand 411 and of the first additional brand 410 than joint fans 421 of the brand 411 and of the second additional brand 412. Hence, in FIG. 4, the brand 411 and the first additional brand 410 share more fans than the brand 411 and the second additional brand 412. In various embodiments, the social networking system uses different data about joint fans in recommending endorsements. For example, the social networking system uses an absolute number of joint fans or calculates the percentage of fans of the potential endorser which are joint fans. These metrics can be provided to an operator of the brand 411 to suggest potential connections with another brand to aid in advertisement of the brand 411. Using the joint fan information, the brand 411 may determine whether to establish a connection with another brand, seek an endorsement or endorse the other brand, or advertise using another brand. A brand owner may choose to establish an endorsement with a brand which has the highest number of joint fans, believing the fans who like that brand are likely to also like the advertising brand. A brand owner may also choose to advertise with a brand with a lower number of joint fans, reasoning that the advertising brand does not have sufficient awareness by the fans of the brand with the lower number of joint fans.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
storing, in a social networking system, a first brand profile associated with a first brand, a second brand profile associated with a second brand, and a set of connections between the first brand and a plurality of users of the social networking system;
receiving an endorsement request from the second brand, the endorsement request comprising an interaction between the first brand and the second brand;
responsive to the endorsement request, establishing a connection between the first brand and the second brand;
receiving an advertisement request from the second brand, the advertisement request comprising a request to communicate the connection between the first brand and the second brand to one or more users who have connections to the first brand; and
providing an advertisement for display to at least one user connected to the first brand, the advertisement including a description of the connection between the first brand and the second brand.

2. The computer-implemented method of claim 1, wherein the at least one advertisement further includes content posted to the social networking system by the first brand.

3. The computer-implemented method of claim 2, wherein the content posted to the social networking system by the first brand is selected based on a user profile associated with the at least one user.

4. The computer-implemented method of claim 2, wherein the content posted to the social networking system by the first brand is selected based on social networking content requested by the at least one user.

5. The computer-implemented method of claim 1, wherein the interaction between the first and second brand comprises an endorsement of the second brand by the first brand.

6. The computer-implemented method of claim 1, wherein establishing the connection between the first brand and the second brand comprises:
requesting approval of the endorsement request by the first brand; and
responsive to receiving approval of the endorsement request by the first brand, establishing the connection between the first brand and the second brand.

7. A computer-implemented method comprising:
storing, in a social networking system, a brand profile associated with a first brand and a first set of connections between the first brand and users of the social networking system;
responsive to receiving an endorsement request associated with the first brand, establishing a connection between the first brand and a second brand associated with a second user profile in the social networking system;
receiving an advertisement from the second brand, the advertisement including a description of an endorsement between the first brand and the second brand specified by the endorsement request; and
serving the advertisement including the description of the endorsement between the first brand and the second brand to a user in the first set of connections.

8. The computer-implemented method of claim 7, wherein the endorsement request specifies an endorsement from the first brand to the second brand.

9. The computer-implemented method of claim 7, wherein the endorsement request specifies an endorsement from the second brand to the first brand.

10. The computer-implemented method of claim 7, wherein the endorsement request specifies a bi-directional relationship between the first and second brands.

11. The computer-implemented method of claim 7, wherein serving the advertisement comprises:
receiving a request from at least one user of the social networking system to access content maintained by the social networking system;
presenting the content and the advertisement including the description of the endorsement between the additional brand and the brand to the at least one user.

12. A computer-implemented method comprising:
storing, in a social networking system, a plurality of user profiles associated with brands using the social networking system and a set of connections between the brands and users of the social networking system, the plurality of user profiles including a brand profile for an advertising brand;
identifying users of the social networking system connected to the advertising brand and connected to one or more additional brands;
selecting one or more candidate brand connections from the one or more additional brands based on users connected to the advertising brand and to the additional brands;
identifying the one or more candidate brand connections to the advertising brand; and
responsive to receiving a connection request from the advertising brand selecting one or more candidate brand connections, modifying the user profile associated with the advertising brand to include a connection to the selected one or more candidate brand connections.

13. The computer-implemented method of claim 12, further comprising:
providing an advertisement to a user of the social networking system, the advertisement including the connection between the advertising brand and the selected one or more candidate brand connections.

14. The computer-implemented method of claim 12, wherein the candidate brand connections are selected based in part on users who are connected to both the advertising brand and to an additional brands.

15. The computer-implemented method of claim 12, wherein the candidate brand connections are selected based in part on an absolute size of the group of users who jointly have connections to both the advertising brand and to an additional brand.

16. The computer-implemented method of claim 12, wherein the brand connections are selected based in part on a percentage of users connected to the additional brand that are connected to both the advertising brand and to an additional brand.
